(19) United States
(12) Patent Application Publication
(10) Pub. No.: US 2024/0340080 A1
(43) Pub. Date: Oct. 10, 2024

(54) ELECTRONIC DEVICE FOR PERFORMING SATELLITE COMMUNICATION AND OPERATING METHOD THEREOF

(71) Applicant: Samsung Electronics Co., Ltd., Suwon-si (KR)

(72) Inventor: Seokkun HYUNG, Suwon-si (KR)

(21) Appl. No.: 18/584,490

(22) Filed: Feb. 22, 2024

Related U.S. Application Data
(63) Continuation of application No. PCT/KR2024/095286, filed on Feb. 16, 2024.

(30) Foreign Application Priority Data
Apr. 4, 2023 (KR) 10-2023-0044241
Apr. 18, 2023 (KR) 10-2023-0050480

(51) Int. Cl. H04B 7/185; H04W 76/27

(52) U.S. Cl. CPC H04B 7/18539; H04W 76/27

(57) ABSTRACT

An embodiment of the disclosure relates to an apparatus and a method for performing satellite communication by an electronic device. According to an embodiment, the electronic device may include: a communication circuit, a memory, and at least one processor, comprising processing circuitry, wherein at least one processor, individually and/or collectively, may be configured to: identify transmission delay time of a satellite based on the satellite being detected, control the electronic device to transmit a signal related to an RACH to the satellite through the communication circuit, switch to an inactive state, based on transmission of the signal related to the RACH, and switch to an active state to identify a response signal related to the RACH based on the inactive time configured based on the transmission delay time of the satellite elapsing.

### CROSS-REFERENCE TO RELATED APPLICATIONS

This application is a continuation of International Application No. PCT/KR2024/095286 designating the United States, filed on Feb. 16, 2024, in the Korean Intellectual Property Receiving Office and claiming priority to Korean Patent Application Nos. 10-2023-0044241, filed on Apr. 4, 2023, and 10-2023-0050480, filed on Apr. 18, 2023, in the Korean Intellectual Property Office, the disclosures of each of which are incorporated by reference herein in their entireties.

### BACKGROUND

### Field

The disclosure relates to an electronic device for performing satellite communication and an operating method thereof.

### Description of Related Art

A wireless communication system may provide wireless connection to electronic devices to enable wireless communication with various electronic devices. The wireless communication system may provide wireless communication of electronic devices by allocating radio frequency resources to electronic devices through control of a base station installed on the ground. Due to the physical limitation that the location where the base station is installed is on the ground, it may be difficult for the wireless communication system to provide wireless connection to electronic devices located in the ocean and/or above a certain altitude.

A wireless communication system is being developed in the form of combining satellite networks and terrestrial networks to overcome the physical limitations of base stations located on the ground and expand the scope of providing wireless connections to electronic devices globally. By combining the terrestrial network and the satellite network, the wireless communication system may provide wireless communication with electronic devices even in areas where it is difficult to establish a terrestrial network or in disaster situations.

When an electronic device (e.g., a user equipment (UE)) of a wireless communication system wants to perform a wireless connection with another electronic device (e.g., another UE or a base station) through a satellite network, the electronic device may register with the satellite network through a satellite detected through a search (or scan) related to the satellite. For example, the electronic device may register with the satellite network through a random access channel (RACH) using a satellite.

When registering with the satellite network through the RACH, the electronic device may transmit a message related to the RACH (e.g., a RACH preamble and/or a radio resource control (RRC) connection request) to the satellite. The electronic device may register with the satellite network based on a response message (e.g., RAR and/or RRC connection setup) related to the RACH received from the satellite within a specified time (e.g., a RACH response (RAR) window and/or a contention resolution (CR) timer).

The electronic device may not be able to receive a response message related to the RACH from the satellite within a specified time due to transmission delay with the satellite, and thus registration with the satellite network may be limited.

The electronic device cannot receive the response message related to the RACH from the satellite within the specified time due to the transmission delay with the satellite, but by retransmitting the message related to the RACH based on the lapse of the specified time, unnecessary power consumption may increase.

### SUMMARY

Embodiments of the disclosure may provide an apparatus and method for registering an electronic device with a satellite network.

The technical problems to be addressed in the disclosure are not limited to the above-mentioned technical problems, and other technical problems not mentioned will be clearly understood by those skilled in the art to which the disclosure belongs from the following description.

According to an example embodiment, an electronic device may include: a communication circuit, and at least one processor, comprising processing circuitry, operatively connected to the communication circuit. According to an example embodiment, at least one processor, individually and/or collectively, may be configured to: identify a transmission delay time of a satellite based on the satellite being detected; control the electronic device to transmit a signal related to a random access channel (RACH) to the satellite; switch to an inactive state based on transmission of the signal related to the RACH; and switch to an active state to identify a response signal related to the RACH based on the inactive time configured based on the transmission delay time of the satellite elapsing.

According to an example embodiment, a method of operating an electronic device may include: identifying a transmission delay time of a satellite based on the satellite being detected; transmitting a signal related to a random access channel (RACH) to the satellite; switching to an inactive state based on transmission of the signal related to the RACH; and switching to an active state to identify a response signal related to the RACH based on the inactive time configured based on the transmission delay time of the satellite elapsing.

According to an example embodiment, a non-transitory computer-readable storage medium (or a computer program product) storing one or more programs may be provided. According to an example embodiment, when a satellite is detected, one or more programs, when executed by at least one processor, individually and/or collectively, of the electronic device, may cause the electronic device to perform operations comprising: identifying a transmission delay time of the satellite, transmitting a signal related to the random access channel (RACH) to the satellite, switching to an inactive state based on the transmission of the signal related to the RACH, and switching to an active state and performing an operation of identifying the response signal related to the RACH based on an inactive time configured based on the transmission delay time of the satellite elapsing.

According to an example embodiment of the disclosure, the electronic device may smoothly register with the satellite network by configuring a specified time period for waiting to receive a response message related to the RACH based on a transmission delay time with the satellite.

According to an example embodiment, the electronic device may reduce power consumption for satellite communication by operating in a low power mode for a specified time configured based on the transmission delay time with the satellite when registering with the satellite network.

The effects that may be obtained from various example embodiments of the disclosure are not limited to the effects mentioned above, and other effects not mentioned will be clearly understood by those skilled in the art to which various example embodiments of the disclosure belong from the following description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of illustrating an example electronic device in a network environment according to various embodiments;

FIG. 2 is a diagram illustrating an example of a wireless communication system for satellite communication according to various embodiments;

FIG. 3 is a block diagram illustrating an example configuration of an electronic device for performing satellite communication according to various embodiments;

FIG. 4 is a flowchart illustrating an example method for transmitting a message from an electronic device to a satellite according to various embodiments;

FIG. 5 is a flowchart illustrating an example method for configuring an inactive time in an electronic device according to various embodiments;

FIG. 6 is a flowchart illustrating an example method for retransmitting a message related to registering an electronic device with a satellite network according to various embodiments;

FIG. 7 is a signal flow diagram illustrating example operations for registering an electronic device with a satellite network through a first method type satellite according to various embodiments; and

FIG. 8 is a signal flow diagram illustrating example operations for registering an electronic device with a satellite network through a second method type satellite according to various embodiments.

### DETAILED DESCRIPTION

Hereinafter, various example embodiments are described in greater detail with reference to the accompanying drawings.

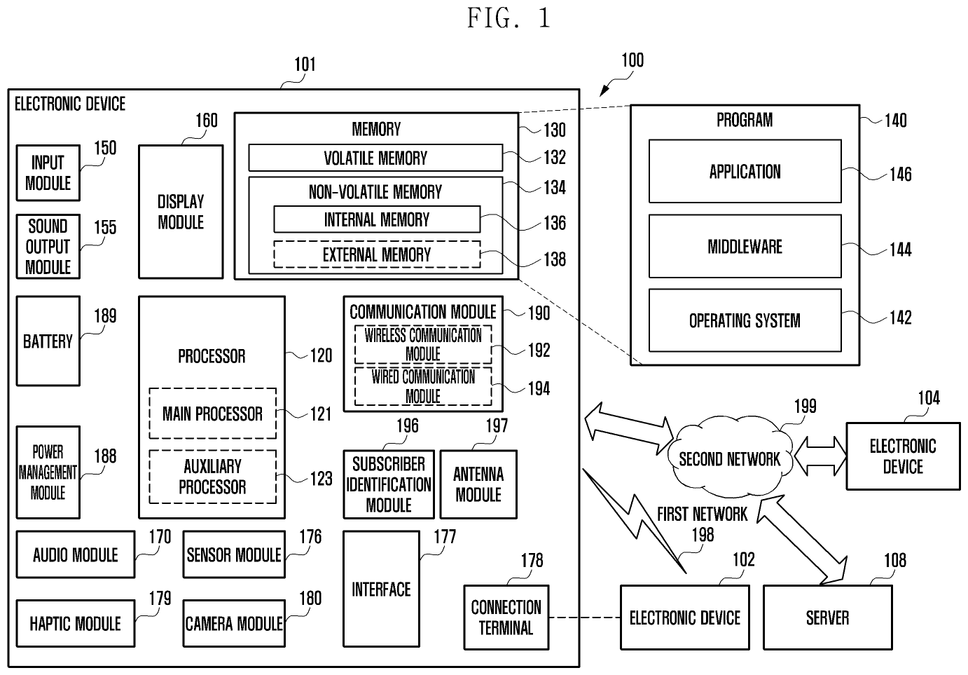

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC. According to an embodiment, the subscriber identification module 196 may include a plurality of subscriber identification modules. For example, the plurality of subscriber identification modules may store different subscriber information.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating clement may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include patch array antennas and/or dipole array antennas.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

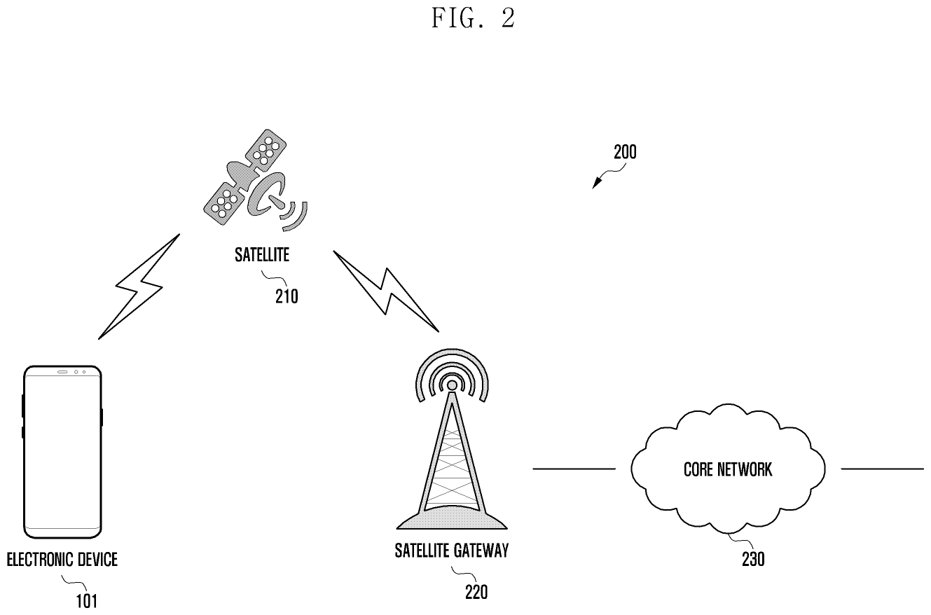

FIG. 2 is a diagram illustrating an example of a wireless communication system for satellite communication according to various embodiments. As an example, the electronic device 101 of FIG. 2 may be at least partially similar to the electronic device 101 of FIG. 1, or may include other embodiments of the electronic device.

According to an embodiment referring to FIG. 2, the wireless communication system 200 may include at least one satellite 210 supporting wireless communication of the electronic device 101. For example, the satellite 210 may revolve around the Earth according to a specified orbit.

According to an embodiment, the wireless communication system 200 may include at least one satellite gateway 220 that connects a satellite network by the satellite 210 to a public data network (e.g., a terrestrial network or a terrestrial core network). For example, the satellite gateway 220 may include a base station (e.g., evolved node B (NB) or next generation node B (gNB)) located on the ground where satellite communication is possible with the satellite 210. For example, the satellite gateway 220 may connect a communication between a satellite network and the terrestrial core network 230. As an example, the satellite network is a network wirelessly connected based on a satellite 210, and may also be referred to as a non-terrestrial network (NTN). As an example, the terrestrial network may represent a network wirelessly connected based on a base station (e.g., satellite gateway 220) located on the ground.

According to an embodiment, the satellite 210 may operate in a first method serving as a signal relay or a second method serving as a base station. For example, the first method is a method in which the satellite 210 relays a signal (e.g., analog) between the electronic device 101 and a base station (e.g., the satellite gateway 220) that processes signals on the ground, and may include a bent-pipe method. For example, the second method is a method in which the satellite 210 processes signals transmitted and/or received to and/or from the electronic device 101, and may include a regenerative method.

According to an embodiment, the satellite 210 may support registering the electronic device 101 located in a service area (e.g., coverage) of the satellite 210 with a satellite network. The satellite 210 may support wireless communication of the electronic device 101 registered with the satellite network.

According to an embodiment, the electronic device 101 may register with the satellite network based on the transmission delay with the satellite 210. For example, when the satellite 210 is detected through a satellite-related search (or scan), the electronic device 101 may identify the transmission delay (or transmission delay time) with the satellite 210. The electronic device 101 may identify (or configure) an inactive time related to receiving a message to the satellite 210 based on the transmission delay (or transmission delay time) with the satellite 210.

For example, the electronic device 101 may transmit a message related to the RACH to the satellite 210 for registration with the satellite network. As an example, the message related to the RACH may include a RACH preamble and/or a radio resource control (RRC) connection request message.

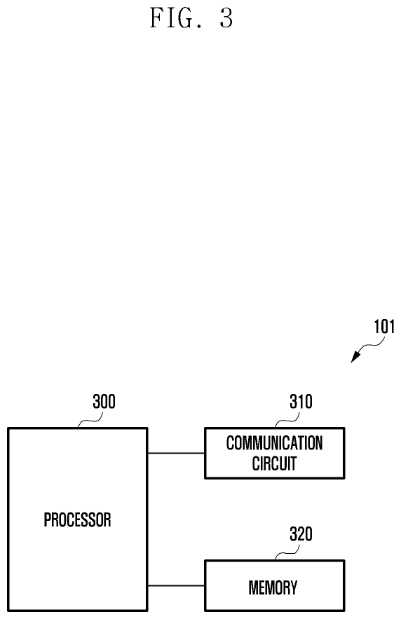

For example, the electronic device 101 may switch (or change) the electronic device 101 to an inactive state based on transmission of a message related to the RACH. As an example, switching to the inactive state may include a function related to satellite communication and/or a series of operations for switching an internal circuit (e.g., the communication circuit 310 of FIG. 3) related to satellite communication to an inactive state in the electronic device 101.

For example, when the inactive time configured based on the transmission delay (or transmission delay time) with the satellite 210 has elapsed, the electronic device 101 may switch to an active state to identify whether a response message related to the RACH is received. As an example, the lapse of the inactive time may include a series of operations in which the running time of a timer that runs for the inactive time configured based on the transmission delay with the satellite expires from the time the electronic device switches to an inactive state. As an example, the response message related to the RACH may include a RACH response (e.g., RACH response (RAR)) message and/or an RRC connection setup message.

For example, the electronic device 101 may register with the satellite network based on the response message related to the RACH received from the satellite 210 during a specified time. As an example, the specified time is a time for the electronic device 101 to wait for reception of the response message related to the RACH, and may include a RACH response (RAR) window and/or a contention resolution (CR) timer. As an example, the specified time may be configured based on the elapsed time from when the electronic device 101 is switched to an active state.

FIG. 3 is a block diagram illustrating an example configuration of an electronic device for performing satellite communication according to various embodiments. As an example, the electronic device 101 of FIG. 3 may be at least partially similar to the electronic device 101 of FIG. 1 or 2, or may include various embodiments of the electronic device.

According to an embodiment referring to FIG. 3, the electronic device 101 may include a processor (e.g., including processing circuitry) 300, a communication circuit (or communication circuitry) 310, and/or a memory 320. According to an embodiment, the processor 300 may be substantially the same as the processor 120 of FIG. 1, or may be included in the processor 120. The communication circuit 310 may be substantially the same as the wireless communication module 192 of FIG. 1, or may be included in the wireless communication module 192. The memory 320 may be substantially the same as the memory 130 of FIG. 1, or may be included in the memory 130. According to an embodiment, the processor 300 may be operatively, functionally and/or electrically connected to the communication circuit 310 and/or the memory 320. The processor 300 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, when the satellite 210 is detected through a satellite-related search (or scan), the processor 300 may identify the transmission delay time with the satellite 210. For example, the processor 300 may identify the transmission delay time with the satellite 210 based on at least one of a reference delay time defined in a standard (e.g., TS22.261) related to satellite communications, and a transmission delay time related to timing information related to a satellite network or the orbit of the satellite 210. For example, the transmission delay time with the satellite 210 may include the minimum value of the reference delay time defined in a standard (e.g., TS22.261) related to satellite communications, and the transmission delay time related to timing information related to a satellite network and the orbit of the satellite 210. As an example, the reference delay time defined in a standard related to satellite communication may include minimum transmission delay time information related to the satellite orbit, as illustrated in Table 1 below. As an example, the reference delay time defined in a standard related to satellite communication may include a minimum transmission delay time of about 3 ms when the satellite 210 is in a low orbit (e.g., low earth orbit (LEO). As an example, the reference delay time defined in a standard related to satellite communication may include a minimum transmission delay time of about 27 ms when the satellite 210 is in a medium orbit (e.g., medium earth orbit (MEO). As an example, the reference delay time defined in a standard related to satellite communication may include a minimum transmission delay time of about 120 ms when the satellite 210 is in a geostationary orbit (e.g., geostationary earth orbit (GEO)).

TABLE 1

| | UE to serving satellite propagation | | UE to ground max |
|---|---|---|---|
| | delay [ms] [NOTE 1] | | propagation delay |
| | Min | Max | [ms] [NOTE 2] |
| LEO | 3 | 15 | 30 |
| MEO | 27 | 43 | 90 |
| GEO | 120 | 140 | 280 |

[NOTE 1]:
The serving satellite provides the satellite radio link to the UE
[NOTE 2]:
delay between UE and ground station via satellite link; Inter satellite links are not considered

As an example, timing information related to the satellite network may be included in ta-common in the NTN-config information element (IE) of the system information block (SIB) 19 received from the satellite 210, as illustrated in Table 2 (TS 38.331) below.

TABLE 2

| NTN-Config-r17 ::= | SEQUENCE { | |
|---|---|---|
| epochTime-r17 | EpochTime-r17 | OPTIONAL, |

-- Need R

| | |
|---|---|
| ntn-UlSyncValidityDuration-r17 | ENUMERATED{ s5, s10, s15, s20, s25, s30, s35, |

| | |
|---|---|
| s40, s45, s50, s55, s60, s120, s180, s240, s900} | OPTIONAL, -- Cond |

SIB19

| | | |
|---|---|---|
| cellSpecificKoffset-r17 | INTEGER(1..1023) | OPTIONAL, -- |

Need R

| | | |
|---|---|---|
| kmac-r17 | INTEGER(1..512) | OPTIONAL, |

-- Need R

| | | |
|---|---|---|
| ta-Info-r17 | TA-Info-r17 | OPTIONAL, -- |

Need R

| | | |
|---|---|---|
| ntn-PolarizationDL-r17 | ENUMERATED {rhcp,lhcp,linear} | OPTIONAL, -- |

Need R

| | | |
|---|---|---|
| ntn-PolarizationUL-r17 | ENUMERATED {rhcp,lhcp,linear} | OPTIONAL, -- |

Need R

| | | |
|---|---|---|
| ephemerisInfo-r17 | EphemerisInfo-r17 | OPTIONAL, -- |

Need R

| | |
|---|---|
| ta-Report-r17 | ENUMERATED {enabled} |

OPTIONAL, -- Need R
...
}

| | |
|---|---|
| EpochTime-r17 ::= | SEQUENCE { |
| sfn-r17 | INTEGER(0..1023), |
| subFrameNR-r17 | INTEGER(0..9) |

}

| TA-Info-r17 ::= | SEQUENCE { | |
|---|---|---|
| ta-Common-r17 | INTEGER(0..66485757), | |
| ta-CommonDrift-r17 | INTEGER(−257303..257303) | OPTIONAL, |

-- Need R

| | | |
|---|---|---|
| ta-CommonDriftVariant-r17 | INTEGER(0..28949) | OPTIONAL |

-- Need R
}

As an example, the transmission delay time related to the orbit of the satellite 210 may be calculated based on orbit information (e.g., orbit radius (semiMajorAxis)) of the satellite 210. As an example, the orbit information of the satellite 210 may be included in the orbital in ephemrisInfo IE of NTN-config IE included in the SIB 19 received from the satellite 210, as illustrated in Table 3 (TS 38.331) below.

TABLE 3

| | |
|---|---|
| EphemerisInfo-r17 ::= | CHOICE { |
| positionVelocity-r17 | Position Velocity-r17, |
| orbital-r17 | Orbital-r17 |

}

| | |
|---|---|
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}

| | |
|---|---|
| Orbital-r17 ::= | SEQUENCE { |
| semiMajorAxis-r17 | INTEGER (0..8589934591), |
| eccentricity-r17 | INTEGER (0..1048575), |
| periapsis-r17 | INTEGER (0..268435455), |
| longitude-r17 | INTEGER (0..268435455), |
| inclination-r17 | INTEGER (−67108864..67108863), |
| meanAnomaly-r17 | INTEGER (0..268435455) |

}
PositionStateVector-r17 ::= INTEGER (−33554432..33554431)
VelocityStateVector-r17 ::= INTEGER (−131072..131071)

According to an embodiment, the processor 300 may identify an inactive time related to receiving a message to the satellite 210 based on the transmission delay time with the satellite 210. For example, when the satellite 210 operates in a first method (e.g., bent-pipe method), the inactive time may be configured as illustrated in Equation 1 below.

$$inactive timer = 4 \times propagation delay \qquad [ Equation 1 ]$$

As an example, the inactive timer may represent the running time of a timer related to the inactive time, and propagation delay may represent the transmission delay time with the satellite 210.

For example, when the satellite 210 operates in a second method (e.g., regenerative method), the inactive time may be configured as illustrated in Equation 2 below.

$$inactive timer = 2 \times propagation delay \qquad [ Equation 2 ]$$

As an example, the inactive timer may represent the running time of a timer related to the inactive time, and propagation delay may represent the transmission delay time with the satellite 210.

According to an embodiment, the processor 300 may control the communication circuit 310 to access the satellite 210 based on the inactive time. For example, when the satellite 210 is detected, for access to the satellite 210, the processor 300 may control the communication circuit 310 to transmit a random access channel (RACH) preamble to the satellite 210. The processor 300 may switch the electronic device 101 to an inactive state based on transmission of the RACH preamble. As an example, switching to the inactive state may include a series of operations for switching the functions related to satellite communication in the electronic device 101 and/or the communication circuit 310 to the inactive state. As an example, the access operation to the satellite 210 may represent a series of operations in which the electronic device 101 registers with the satellite network. As an example, detection of the satellite 210 may include a series of operations for receiving a signal exceeding a specified quality from the satellite 210.

For example, when an inactive time configured based on the transmission delay time of the satellite 210 has elapsed, the processor 300 may switch the electronic device 101 to an active state to identify whether a RACH response (e.g., RAR) message is received. As an example, switching to the active state of the electronic device 101 may be performed when the running time of a timer that runs for the inactive time expires from the time when the electronic device 101 is deactivated.

For example, when the RACH response message is received within the specified first reference time, the processor 300 may control the communication circuit 310 to transmit a radio resource control (RRC) connection request message to the satellite 210. The processor 300 may switch the electronic device 101 to an inactive state based on transmission of the RRC connection request signal. As an example, the specified first reference time is a specified waiting time (e.g., a RAR window) for identifying the reception of the RACH response message, and may be configured based on the time when the electronic device 101 is switched to an active state.

For example, when an inactive time configured based on the transmission delay time of the satellite 210 has elapsed, the processor 300 may switch the electronic device 101 to an active state to identify whether an RRC connection setup message is received. As an example, switching to the active state of the electronic device 101 may be performed when the running time of a timer that runs for the inactive time expires from the time the electronic device 101 is deactivated.

For example, when the RRC connection setup message is received within the specified second reference time, the processor 300 may determine that the RRC connection with the satellite 210 is completed. The processor 300 may control the communication circuit 310 to transmit an RRC connection setup complete message to the satellite 210 based on the determination that the RRC connection with the satellite 210 is completed. As an example, the specified second reference time is a specified waiting time (e.g., contention resolution (CR)) for identifying the reception of the RRC connection setup message, and may be configured based on the time when the electronic device 101 is switched to an active state.

According to an embodiment, the communication circuit 310 allows the electronic device 101 to transmit and/or receive signals and/or data to and from the satellite 210. According to an embodiment, the communication circuit 310 allows the electronic device 101 to transmit and/or receive signals and/or data to and from at least one external electronic device (e.g., the electronic device 102 or 104 or the server 108 of FIG. 1) included in the terrestrial network.

According to an embodiment, the memory 320 may store various data used by at least one component of the electronic device 101 (e.g., the processor 300 and/or the communication circuit 310). As an example, the data may include information related to the inactive time. According to an embodiment, the memory 320 may store various instructions that may be executed through the processor 300.

According to an example embodiment, an electronic device (e.g., the electronic device 101 of FIG. 1, 2, or 3) may include: a communication circuit (e.g., the wireless communication module 192 of FIG. 1 or the communication circuit 310 of FIG. 3), and at least one processor, comprising processing circuitry, operatively connected to the communication circuit. According to an example embodiment, at least one processor, individually and/or collectively, may be configured to: identify a transmission delay time of a satellite (e.g., the satellite 210 of FIG. 2) based on the satellite being detected; control the electronic device to transmit a signal related to a random access channel (RACH) to the satellite through the communication circuit; switch to an inactive state based on transmission of the signal related to the RACH; and switch to an active state to identify a response signal related to the RACH based on the inactive time configured based on the transmission delay time of the satellite elapsing.

According to an example embodiment, at least one processor, individually and/or collectively, may be configured to identify the transmission delay time of the satellite based on at least one of reference delay information defined in a standard related to a satellite, timing information received from the satellite, or a transmission delay time based on the orbit of the satellite.

According to an example embodiment, at least one processor, individually and/or collectively, may be configured to configure the inactive time based on the operation mode of the satellite and the transmission delay time of the satellite.

According to an example embodiment, at least one processor, individually and/or collectively, may be configured to: control the electronic device to transmit a RACH preamble to the satellite through the communication circuit, switch to an inactive state based on transmission of the RACH preamble, and switch to an active state to identify reception of a RACH response message based on the inactive time elapsing.

According to an example embodiment, at least one processor, individually and/or collectively, may be configured to: identify whether the RACH response message is received during a first reference time specified based on the switching time point to the active state, and control the electronic device to retransmit the RACH preamble to the satellite through the communication circuit based on the RACH response message not being received during the specified first reference time.

According to an example embodiment, at least one processor, individually and/or collectively, may be configured to: control the electronic device to transmit a radio resource control (RRC) connection request message to the satellite through the communication circuit based on the RACH response message being received within the specified first reference time, switch to an inactive state based on transmission of the RRC connection request signal, and switch to an active state to identify reception of an RRC connection setup message based on the inactive time elapsing.

According to an example embodiment, at least one processor, individually and/or collectively, may be configured to: identify whether the RRC connection setup message is received during a second reference time specified based on the switching time point to the active state, and determine that the RRC connection with the satellite is established based on the RRC connection setup message being received within the specified second reference time.

According to an example embodiment, at least one processor, individually and/or collectively, may be configured to control the electronic device to retransmit the RRC connection request signal to the satellite based on the RRC connection setup message not being received during the specified second reference time.

According to an example embodiment, at least one processor, individually and/or collectively, may be configured to switch at least one of the functions related to satellite communication or communication circuits to an inactive state based on the transmission of signals related to the RACH.

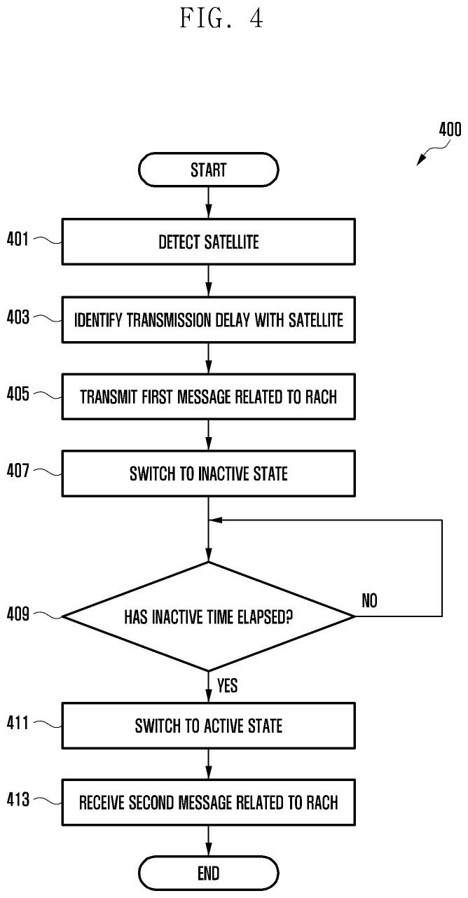

FIG. 4 is a flowchart 400 illustrating an example method for transmitting a message from an electronic device to a satellite according to various embodiments. In the following example embodiments, each operation may be performed sequentially, but is not necessarily performed sequentially. For example, the order of each operation may be changed, and at least two operations may be performed in parallel. As an example, the electronic device of FIG. 4 may be the electronic device 101 of FIG. 1, 2, or 3.

According to an embodiment referring to FIG. 4, in operation 401, an electronic device (e.g., the processor 120 of FIG. 1 or the processor 300 of FIG. 3) may detect the satellite 210 to which the electronic device 101 may access (or register) through a satellite-related search (or scan). For example, when a signal exceeding a specified quality is detected from the satellite 210 through the satellite-related search (or scan), the processor 300 may determine that the electronic device 101 may access (or register) the satellite 210. As an example, the specified quality may represent the minimum communication quality at which the electronic device 101 may decode a signal received from the satellite 210. As an example, the communication quality may include a received signal strength indicator (RSSI), reference signal received quality (RSRQ), reference signal received power (RSRP), signal to interference and noise ratio (SINR), or bit error rate (BER).

According to an embodiment, the electronic device (e.g., the processor 120 or 300) may identify a transmission delay (or transmission delay time) with the satellite 210 in operation 403. For example, the processor 300 may determine the minimum value of the reference delay time defined in the standard related to satellite communication (e.g., TS22.261), timing information related to the satellite network, or transmission delay time related to the orbit of the satellite 210 as the transmission delay with the satellite 210. As an example, the reference delay time defined in the standard related to satellite communication may include minimum transmission delay time information related to satellite orbit defined as illustrated in Table 1. As an example, the timing information related to the satellite network may be included in the ta-common in the NTN-config IE of the SIB 19 received from the satellite 210 defined in Table 2 (TS 38.331). As an example, the transmission delay time related to the orbit of the satellite 210 may be calculated based on the orbit information of the satellite 210 as illustrated in Equation 3 below.

$$propagation {delay}_{3} = ( semiMajorAxis - earth radius ) / C \qquad [ Equation 3 ]$$

As an example, the propagation delay₃ may represent a transmission delay time related to the orbit of the satellite 210, the semiMajorAxis may represent the radius of the orbit of the satellite 210, the earth radius may represent the radius of the Earth (e.g., about 6,371 Km), and the C may represent the speed of light (e.g., approximately 299,792 Km/sec).

According to an embodiment, in operation 405, for access to the satellite 210, the electronic device (e.g., the processor 120 or 300) may transmit a first message related to the RACH to the satellite 210. As an example, the message related to the RACH may include a RACH preamble and/or a radio resource control (RRC) connection request message.

According to an embodiment, in operation 407, the electronic device (e.g., the processor 120 or 300) may be switched to an inactive state based on transmission of the first message related to the RACH. For example, the processor 300 may switch functions related to satellite communication and/or an internal circuit (e.g., the communication circuit 310) to inactive states based on transmission of the first message related to the RACH.

According to an embodiment, in operation 409, the electronic device (e.g., the processor 120 or 300) may identify whether a configured inactive time elapses based on the transmission delay with the satellite 210. For example, the processor 300 may drive a timer that runs for an inactive time based on the switching of the electronic device 101 to an inactive state. The processor 300 may identify whether the running time of the timer expires. For example, the inactive time may be set based on Equation 1 or Equation 2 based on the transmission time with the satellite 210 and the operation mode of the satellite 210. As an example, information related to the operation mode of the satellite 210 may be obtained from the SIB received from the satellite 210 or a separate server.

According to an embodiment, when the inactive time has not elapsed (e.g., ‘No’ in operation 409), in operation 409, the electronic device (e.g., the processor 120 or 300) may identify whether the configured inactive time elapses based on the transmission delay with the satellite 210. For example, when the timer driven based on the switching to the inactive state is running, the processor 300 may determine that the configured inactive time based on the transmission delay with the satellite 210 has not elapsed.

According to an embodiment, when the inactive time has elapsed (e.g., ‘Yes’ in operation 409), in operation 411, the electronic device (e.g., the processor 120 or 300) may be switched to an active state. For example, when the operation of the timer driven based on the switching to the inactive state expires, the processor 300 may determine that the configured inactive time has elapsed based on the transmission delay with the satellite 210. The processor 300 may switch a function related to satellite communication and/or an internal circuit (e.g., the communication circuit 310) to an active state based on the lapse of the inactive time.

According to an embodiment, in operation 413, the electronic device (e.g., the processor 120 or 300) may receive a second message related to the RACH from the satellite 210. For example, when the electronic device 101 is switched to an active state, the processor 300 may identify whether the second message related to the RACH is received from the satellite 210 for a specified time through the communication circuit 310. As an example, the second message related to the RACH may include a RACH response (e.g., RAR) message and/or an RRC connection setup message. As an example, the specified time is a time for the electronic device 101 to wait for the reception of the second message (or response message) related to the RACH, and may include a RAR window and/or a contention resolution (CR) timer. As an example, the specified time may be configured based on the time when the electronic device 101 is switched to the active state.

According to an embodiment, the electronic device 101 (e.g., the processor 120 or 300) may determine that the electronic device accesses the satellite 210 based on the RRC connection setting message received from the satellite 210 within a specified time. The electronic device 101 (e.g., the processor 120 or 300) may transmit an RRC connection setup complete message to the satellite 210 based on completion of the access to the satellite 210.

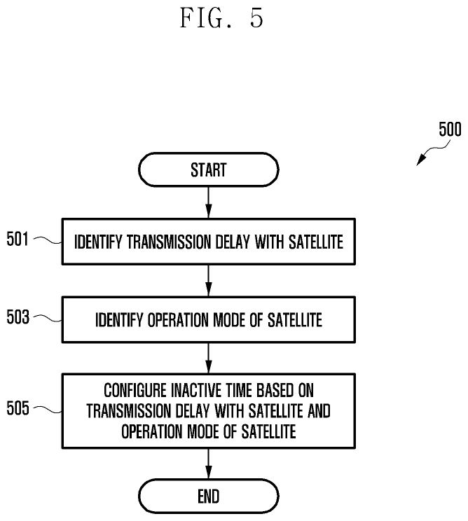

FIG. 5 is a flowchart 500 illustrating an example method for configuring an inactive time in an electronic device according to various embodiments. According to an embodiment, at least a part of FIG. 5 may include a detailed operation of operation 403 of FIG. 4. In the examples, each operation may be performed sequentially, but is not necessarily performed sequentially. For example, the order of each operation may be changed, and at least two operations may be performed in parallel. As an example, the electronic device of FIG. 5 may be the electronic device 101 of FIG. 1, 2, or 3.

According to an embodiment referring to FIG. 5, when detecting the satellite 210 that may be accessed (or registered) by the electronic device 101 (e.g., operation 401 of FIG. 4), in operation 501, the electronic device (e.g., the processor 120 of FIG. 1 or the processor 300 of FIG. 3) may identify the transmission delay (or transmission delay time) with the satellite 210. For example, the processor 300 may configure the transmission delay with the satellite 210 based on the minimum value of the reference delay time defined in the standard related to satellite communication (e.g., TS22.261), timing information related to the satellite network, or transmission delay time related to the orbit of the satellite 210. As an example, the reference delay time defined in the standard related to satellite communication may include minimum transmission delay time information related to satellite orbit defined as illustrated in Table 1. As an example, the timing information related to the satellite network may be included in the ta-common in the NTN-config IE of the SIB 19 received from the satellite 210 defined in Table 2 (TS 38.331). As an example, the transmission delay time related to the orbit of the satellite 210 may be calculated based on the orbit information (e.g., radius of satellite orbit) of the satellite 210.

According to an embodiment, in operation 503, the electronic device (e.g., the processor 120 or 300) may identify the operation mode of the satellite 210. For example, the satellite 210 may operate in a first method serving as a signal relay or a second method serving as a base station. As an example, the first method is a method in which the satellite 210 relays a signal (e.g., analog) between the electronic device 101 and a base station (e.g., the satellite gateway 220) that processes signals on the ground, and may include a bent-pipe method. As an example, the second method is a method in which the satellite 210 processes signals transmitted and/or received to and/or from the electronic device 101, and may include a regenerative method.

According to an embodiment, in operation 505, the electronic device (e.g., the processor 120 or 300) may configure the inactive time of the electronic device 101 related to satellite communication based on the transmission delay with the satellite 210 and the operation mode of the satellite 210. For example, when the satellite 210 operates in the first method (e.g., bent-pipe method), the inactive time of the electronic device 101 may be configured based on a first reference multiple (e.g., about 4 times) of the transmission delay with the satellite 210 as illustrated in Equation 1. For example, when the satellite 210 operates in the second method (e.g., regenerative method), the inactive time of the electronic device 101 may be configured based on a second reference multiple (e.g., about 2 times) of the transmission delay with the satellite 210 as illustrated in Equation 2. For example, in the inactive time of the electronic device 101, an offset time related to satellite communication may be added to a multiple of the transmission delay with the satellite 210 based on the operation mode of the satellite 210. As an example, the offset time may be configured based on the satellite communication method.

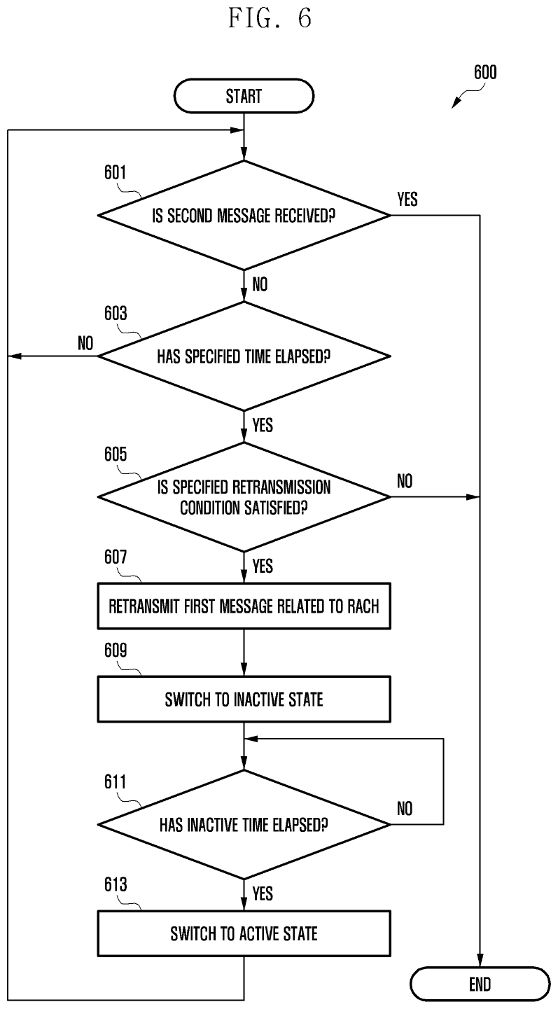

FIG. 6 is a flowchart 600 illustrating an example method for retransmitting a message related to registering an electronic device with a satellite network according to various embodiments. According to an embodiment, at least a part of FIG. 6 may include a detailed operation of operation 413 of FIG. 4. In the following example, each operation may be performed sequentially, but is not necessarily performed sequentially. For example, the order of each operation may be changed, and at least two operations may be performed in parallel. As an example, the electronic device of FIG. 6 may be the electronic device 101 of FIG. 1, 2, or 3.

According to an embodiment referring to FIG. 6, when the electronic device 101 is switched to an active state (e.g., operation 411 of FIG. 4), in operation 601, the electronic device (e.g., the processor 120 of FIG. 1 or the processor 300 of FIG. 3) may identify whether a second message related to the RACH is received from the satellite 210. As an example, the second message related to the RACH may include a RACH response (e.g., RAR) message related to the RACH preamble and/or an RRC connection setup message related to the RACH preamble.

According to an embodiment, when the electronic device (e.g., the processor 120 or 300) does not receive the second message related to the RACH from the satellite 210 (e.g., ‘No’ in operation 601), in operation 603, the electronic device may identify whether a specified time elapses. For example, the processor 300 may identify whether the specified time elapses from the time when the electronic device 101 is switched to the active state. As an example, the specified time may include a RAR window in which the electronic device 101 waits for the reception of the RACH response message from the satellite 210 and/or a contention resolution (CR) timer in which the electronic device 101 waits for the reception of the RRC connection setup message from the satellite 210.

According to an embodiment, when the specified time has not elapsed (e.g., ‘No’ in operation 603), in operation 601, the electronic device (e.g., the processor 120 or 300) may identify whether the second message related to the RACH is received from the satellite 210.

According to an embodiment, when the specified time has elapsed (e.g., ‘Yes’ in operation 603), in operation 605, the electronic device (e.g., the processor 120 or 300) may identify whether a specified retransmission condition related to the RACH is satisfied. For example, when the number of retransmissions of the first message related to the RACH exceeds the specified reference retransmission number, the processor 300 may determine that the specified retransmission condition related to the RACH is not satisfied. For example, when the number of retransmissions of the first message related to the RACH is less than or equal to the specified reference retransmission number, the processor 300 may determine that the specified retransmission condition related to the RACH is satisfied. As an example, the specified reference retransmission number may include the maximum retransmission number configured to determine whether to retransmit the first message related to the RACH.

According to an embodiment, when the electronic device (e.g., the processor 120 or 300) determines that the specified retransmission condition related to the RACH is not satisfied (e.g., ‘No’ in operation 605), the electronic device may determine that the access to the satellite 210 has failed. For example, when the electronic device 101 determines that the specified retransmission condition is not satisfied without receiving the second message related to the RACH from the satellite 210, the processor 300 may determine that registration to the satellite network through the satellite 210 has failed. For example, the processor 300 may control the output device (e.g., a display) (not illustrated) of the electronic device 101 to output information related to registration failure with the satellite network.

According to an embodiment, when the electronic device (e.g., the processor 120 or 300) determines that a specified retransmission condition related to the RACH is satisfied (e.g., ‘Yes’ in operation 605), in operation 607, the electronic device may retransmit the first message related to the RACH to the satellite 210. For example, the processor 300 may control the communication circuit 310 to retransmit the RACH preamble to the satellite 210 when the RACH response message is not received during a specified first reference time. For example, the processor 300 may control the communication circuit 310 to retransmit the RRC connection request message to the satellite 210 when the RRC connection setup message is not received during a specified second reference time.

According to an embodiment, in operation 609, the electronic device (e.g., the processor 120 or 300) may be switched to an inactive state based on retransmission of the first message related to the RACH. For example, the processor 300 may switch functions related to satellite communication and/or an internal circuit (e.g., the communication circuit 310) to inactive states based on retransmission of the first message related to the RACH.

According to an embodiment, in operation 611, the electronic device (e.g., the processor 120 or 300) may identify whether a configured inactive time elapses based on the transmission delay with the satellite 210. For example, the processor 300 may drive a timer that runs for an inactive time based on the switching of the electronic device 101 to an inactive state. The processor 300 may identify whether the running time of the timer expires. For example, the inactive time may be set based on Equation 1 or Equation 2 based on the transmission time with the satellite 210 and the operation mode of the satellite 210.

According to an embodiment, when the inactive time has not elapsed (e.g., ‘No’ in operation 611), in operation 611, the electronic device (e.g., the processor 120 or 300) may identify whether the configured inactive time elapses based on the transmission delay with the satellite 210. For example, when the timer driven based on the switching to the inactive state is running, the processor 300 may determine that the configured inactive time based on the transmission delay with the satellite 210 has not elapsed.

According to an embodiment, when the inactive time has elapsed (e.g., ‘Yes’ in operation 611), in operation 613, the electronic device (e.g., the processor 120 or 300) may be switched to an active state. For example, when the operation of the timer driven based on the switching to the inactive state expires, the processor 300 may determine that the configured inactive time has elapsed based on the transmission delay with the satellite 210. The processor 300 may switch a function related to satellite communication and/or an internal circuit (e.g., the communication circuit 310) to an active state based on the lapse of the inactive time.

According to an embodiment, in operation 601, the electronic device (e.g., the processor 120 or 300) may identify whether the second message related to the RACH is received from the satellite 210.

According to an embodiment, when the electronic device (e.g., the processor 120 or 300) receives the second message related to the RACH from the satellite 210 (e.g., ‘Yes’ in operation 601), the electronic device may terminate an embodiment for retransmitting a message related to registration with the satellite network. For example, when receiving the RACH response message for a specified first reference time, the processor 300 may control the communication circuit 310 to transmit the RRC connection request message to the satellite 210. For example, when receiving the RRC connection setup message within the specified second reference time, the processor 300 may determine that the access to the satellite 210 is completed. The processor 300 may control the communication circuit 310 to transmit an RRC connection setup complete message to the satellite 210 based on the determination that the access to the satellite 210 has been completed.

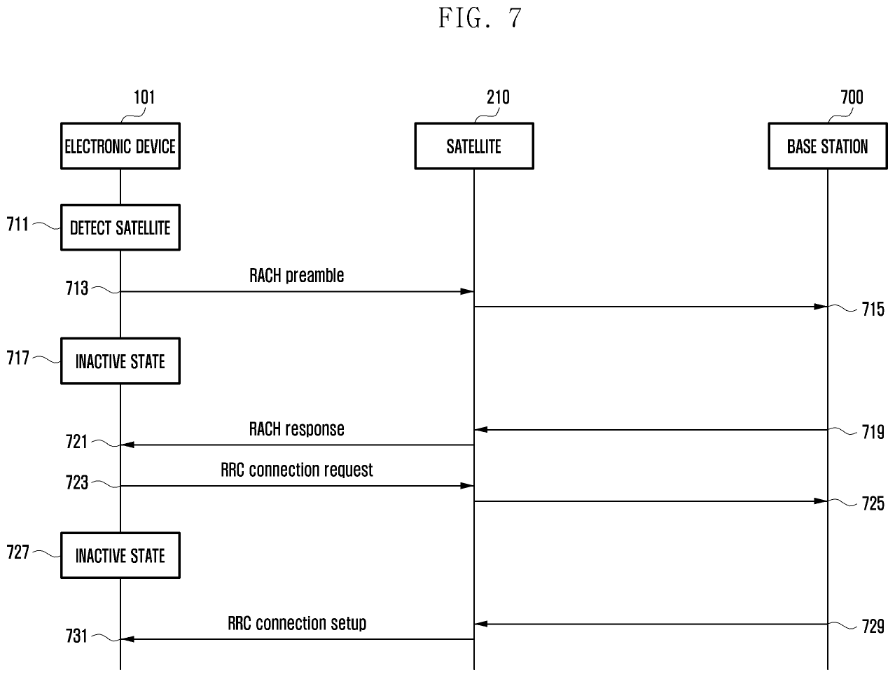

FIG. 7 is a signal flow diagram illustrating example operations for registering an electronic device with a satellite network through a first method type satellite according to various embodiments. As an example, the first method may include a bent-pipe method.

According to an embodiment referring to FIG. 7, the electronic device 101 may detect the satellite 210 to which the electronic device 101 may access (or register) through a satellite-related search (or scan) (operation 711). For example, the detection of the satellite 210 may include a series of operations in which the electronic device 101 detects a signal exceeding a specified quality through a search (or scan) related to the satellite.

According to an embodiment, the electronic device 101 may transmit the RACH preamble to the base station 700 (e.g., the satellite gateway 220 of FIG. 2) through the satellite 210 to access the satellite 210 (operation 713 and operation 715). For example, the electronic device 101 may transmit the RACH preamble to the satellite 210 based on the resource allocation information related to the RACH preamble provided from the satellite 210 (operation 713). When operating in the first method, the satellite 210 may amplify the power of the RACH preamble received from the electronic device 101 and transmit the power-amplified RACH preamble to the base station 700 (operation 715).

According to an embodiment, when transmitting the RACH preamble, the electronic device 101 may operate in an inactive state during configured inactive time based on the transmission delay time with the satellite 210 (operation 717). For example, the electronic device 101 may switch functions related to satellite communication and/or an internal circuit (e.g., communication circuit 310) of the electronic device 101 to an inactive state based on the transmission of the RACH preamble. The electronic device 101 may drive a timer that runs for the inactive time based on the switching to the inactive state. When the operation of the timer expires, the electronic device 101 may identify whether a RACH response message is received by switching the function related to satellite communication and/or the internal circuit (e.g., the communication circuit 310) of the electronic device 101 to the active state. As an example, the function related to satellite communication and/or the internal circuit (e.g., communication circuits 310) of the electronic device 101 may operate in the inactive state while the timer is maintained. As an example, the inactive time may be configured based on Equation 1 when the satellite 210 operates in the first method.

According to an embodiment, the base station 700 may transmit a RACH response (e.g., RAR) message to the electronic device 101 through the satellite 210 based on the reception of the RACH preamble from the electronic device 101 through the satellite 210 (operation 719 and operation 721).

According to an embodiment, when receiving the RACH response message from the satellite 210 within the specified first reference time, the electronic device 101 may transmit an RRC connection request message to the base station 700 through the satellite 210 (operation 723 and operation 725). For example, the electronic device 101 may transmit the RRC connection request message to the satellite 210 based on resource allocation information related to the RRC connection request message included in the RACH response message (operation 723). The satellite 210 may amplify the power of the RRC connection request message received from the electronic device 101 and transmit the power-amplified RACH preamble to the base station 700 (operation 725). For example, the specified first reference time is a specified waiting time (e.g., a RAR window) for identifying the reception of the RACH response message, and may be configured based on the time when the electronic device 101 is switched to an active state. As an example, the specified first reference time may be obtained from the “rar-WindowLength IE” of the SIB received from the satellite 210.

According to an embodiment, when transmitting the RRC connection request message, the electronic device 101 may operate in an inactive state during configured inactive time based on the transmission delay time with the satellite 210 (operation 727). For example, the electronic device 101 may switch functions related to satellite communication and/or an internal circuit (e.g., communication circuit 310) of the electronic device 101 to an inactive state based on the transmission of the RRC connection request message. The electronic device 101 may drive a timer that runs for the inactive time based on the switching to the inactive state. When the operation of the timer expires, the electronic device 101 may identify whether an RRC connection setup message is received by switching the function related to satellite communication and/or the internal circuit (e.g., the communication circuit 310) of the electronic device 101 to the active state.

According to an embodiment, the base station 700 may transmit the RRC connection setup message to the electronic device 101 through the satellite 210 based on the reception of the RRC connection request message from the electronic device 101 through the satellite 210 (operation 729 and operation 731).

According to an embodiment, when the RRC connection setup message is received within the specified second reference time, the electronic device 101 may determine that the RRC connection with the satellite 210 is completed. The electronic device 101 may transmit an RRC connection setup complete message to the base station 700 through the satellite 210 based on the determination that the RRC connection with the satellite 210 is completed. As an example, the specified second reference time is a specified waiting time (e.g., a CR timer) for identifying the reception of the RRC connection setup message, and may be configured based on the time when the electronic device 101 is switched to an active state.

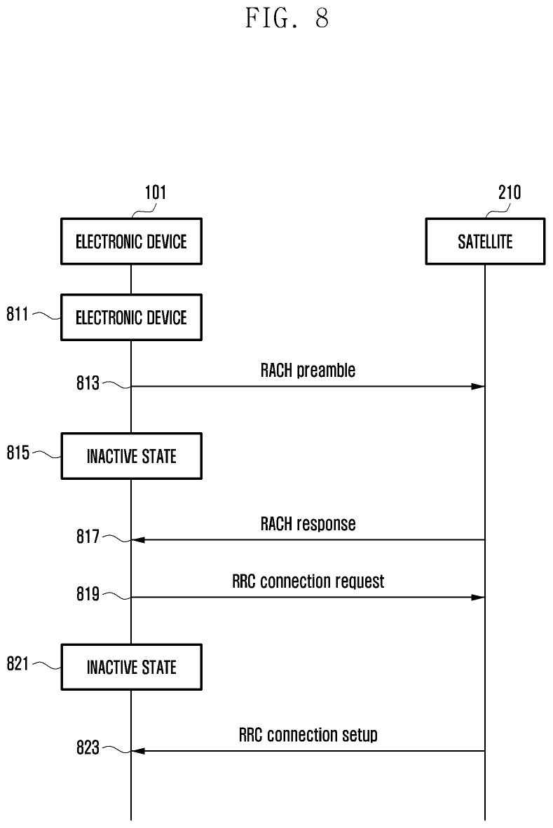

FIG. 8 is a signal flow diagram illustrating example operations for registering an electronic device with a satellite network through a second method type satellite according to various embodiments. As an example, the second method may include a regenerative method.

According to an embodiment referring to FIG. 7, the electronic device 101 may detect the satellite 210 to which the electronic device 101 may access (or register) through a satellite-related search (or scan) (operation 811). For example, the detection of the satellite 210 may include a series of operations in which the electronic device 101 detects a signal exceeding a specified quality through a search (or scan) related to the satellite.

According to an embodiment, the electronic device 101 may transmit the RACH preamble to the satellite 210 to access the satellite 210 (operation 813). For example, the RACH preamble may be transmitted to the satellite 210 based on the resource allocation information related to the RACH preamble provided from the satellite 210. As an example, resource allocation information related to the RACH preamble may be included in a system information block (SIB) 2 received from the satellite 210.

According to an embodiment, when transmitting the RACH preamble, the electronic device 101 may operate in an inactive state during configured inactive time based on the transmission delay time with the satellite 210 (operation 815). For example, the electronic device 101 may switch functions related to satellite communication and/or an internal circuit (e.g., communication circuit 310) of the electronic device 101 to an inactive state based on the transmission of the RACH preamble. The electronic device 101 may drive a timer that runs for the inactive time based on the switching to the inactive state. When the operation of the timer expires, the electronic device 101 may identify whether a RACH response message is received by switching the function related to satellite communication and/or the internal circuit (e.g., the communication circuit 310) of the electronic device 101 to the active state. As an example, the function related to satellite communication and/or the internal circuit (e.g., communication circuits 310) of the electronic device 101 may operate in the inactive state while the timer is maintained. As an example, the inactive time may be configured based on Equation 2 when the satellite 210 operates in the second method (e.g., regenerative method).

According to an embodiment, the satellite 210 may transmit a RACH response (e.g., RAR) message to the electronic device 101 based on the reception of the RACH preamble from the electronic device 101 (operation 817).

According to an embodiment, when receiving the RACH response message from the satellite 210 within the specified first reference time, the electronic device 101 may transmit an RRC connection request message to the satellite 210 (operation 819). For example, the specified first reference time is a specified waiting time (e.g., a RAR window) for identifying the reception of the RACH response message, and may be configured based on the time when the electronic device 101 is switched to an active state. As an example, the specified first reference time may be obtained from the “rar-WindowLength IE” of the SIB received from the satellite 210. For example, the RRC connection request message may be transmitted to the satellite 210 based on resource allocation information related to the RRC connection request message included in the RACH response message.

According to an embodiment, when transmitting the RRC connection request message, the electronic device 101 may operate in an inactive state during configured inactive time based on the transmission delay time with the satellite 210 (operation 821). For example, the electronic device 101 may switch functions related to satellite communication and/or an internal circuit (e.g., communication circuit 310) of the electronic device 101 to an inactive state based on the transmission of the RRC connection request message. The electronic device 101 may drive a timer that runs for the inactive time based on the switching to the inactive state. When the operation of the timer expires, the electronic device 101 may identify whether an RRC connection setup message is received by switching the function related to satellite communication and/or the internal circuit (e.g., the communication circuit 310) of the electronic device 101 to the active state.

According to an embodiment, the satellite 210 may transmit the RRC connection setup message to the electronic device 101 based on the reception of the RRC connection request message from the electronic device 101 (operation 823).

According to an embodiment, when the RRC connection setup message is received within the specified second reference time, the electronic device 101 may determine that the RRC connection with the satellite 210 is completed. The electronic device 101 may transmit an RRC connection setup complete message to the satellite 210 based on the determination that the RRC connection with the satellite 210 is completed. As an example, the specified second reference time is a specified waiting time (e.g., a CR timer) for identifying the reception of the RRC connection setup message, and may be configured based on the time when the electronic device 101 is switched to an active state. As an example, the specified second reference time may be obtained from the “ra-ContentionResolutionTimer” of the SIB received from the satellite 210.

According to an example embodiment, a method of operating an electronic device (e.g., the electronic device 101 of FIG. 1, 2, or 3) may include: identifying a transmission delay time of a satellite (e.g., the satellite 210 of FIG. 2) based on the satellite being detected; transmitting a signal related to a random access channel (RACH) to the satellite; switching to an inactive state based on transmission of the signal related to the RACH; and switching to an active state to identify a response signal related to the RACH based on the inactive time configured based on the transmission delay time of the satellite elapsing.

According to an example embodiment, identifying a transmission delay time of a satellite may include identifying the transmission delay time of the satellite based on at least one of reference delay information defined in a standard related to a satellite, timing information received from the satellite, or a transmission delay time based on the orbit of the satellite.

According to an example embodiment, the method may include configuring the inactive time based on the operation mode of the satellite and the transmission delay time of the satellite.

According to an example embodiment, switching to an inactive state may include: switching to the inactive state based on transmission of a RACH preamble to the satellite and driving a timer that runs for the inactive time configured based on the transmission delay time of the satellite.

According to an example embodiment, identifying the response signal related to the RACH may include: switching to an active state based on driving the timer that runs for the inactive time configured based on the transmission delay time of the satellite expiring and identifying whether the RACH response message is received during a first reference time specified based on the switching time point to the active state.

According to an example embodiment, the method may include retransmitting a RACH preamble to a satellite based on a RACH response message not being received during a specified first reference time.

According to an example embodiment, the method may include: transmitting a radio resource control (RRC) connection request message to the satellite based on the RACH response message being received within the specified first reference time, switching to an inactive state based on transmission of the RRC connection request signal, and switching to an active state to identify an RRC connection setup message based on the inactive time elapsing.

According to an example embodiment, identifying the RRC connection setup message may include: identifying whether the RRC connection setup message is received during a second reference time specified based on the switching time point to the active state and determining that the RRC connection with the satellite is established based on the RRC connection setup message being received within the specified second reference time.

According to an example embodiment, the method may include retransmitting an RRC connection request signal to a satellite based on an RRC connection setup message not being received during a specified second reference time.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a communication circuit; and
at least one processor, comprising processing circuitry, operatively connected to the communication circuit,
wherein at least one processor, individually and/or collectively, is configured to:
identify a transmission delay time of a satellite based on the satellite being detected;
control the electronic device to transmit, via the communication circuit, a signal related to a random access channel (RACH) to the satellite;
switch the electronic device to an inactive state, based on transmission of the signal related to the RACH; and
switch the electronic device to an active state to identify a response signal related to the RACH based on the inactive time configured based on the transmission delay time of the satellite elapsing.

2. The electronic device of claim 1, wherein at least one processor, individually and/or collectively, is configured to identify the transmission delay time of the satellite, based on at least one of reference delay information defined in a standard related to a satellite, timing information received from the satellite, or a transmission delay time based on the orbit of the satellite.

3. The electronic device of claim 1, wherein at least one processor, individually and/or collectively, is configured to configure the inactive time, based on the operation mode of the satellite and the transmission delay time of the satellite.

4. The electronic device of claim 3, wherein the operation mode of the satellite includes at least one of bent-pipe method or regenerative method.

5. The electronic device of claim 1, wherein at least one processor, individually and/or collectively, is configured to:
control the electronic device to transmit, via the communication circuit, a RACH preamble to the satellite;
switch the electronic device to an inactive state, based on transmission of the RACH preamble; and
switch the electronic device to an active state to identify reception of a RACH response message based on the inactive time elapsing.

6. The electronic device of claim 5, wherein at least one processor, individually and/or collectively, is configured to:
identify whether the RACH response message is received during a first reference time specified based on the switching time point to the active state; and
control the electronic device to retransmit, via the communication circuit, the RACH preamble to the satellite based on the RACH response message not being received during the specified first reference time.

7. The electronic device of claim 6, wherein at least one processor, individually and/or collectively, is configured to:
control the electronic device to transmit, via the communication circuit, a radio resource control (RRC) connection request message to the satellite based on the RACH response message being received within the specified first reference time;
switch the electronic device to an inactive state based on transmission of the RRC connection request signal; and
switch the electronic device to an active state to identify reception of an RRC connection setup message based on the inactive time elapsing.

8. The electronic device of claim 7, wherein at least one processor, individually and/or collectively, is configured to:
identify whether the RRC connection setup message is received during a second reference time specified based on the switching time point to the active state; and
determine that the RRC connection with the satellite is established based on the RRC connection setup message being received within the specified second reference time.

9. The electronic device of claim 8, wherein at least one processor, individually and/or collectively, is configured to control the electronic device to retransmit, via the communication circuit, the RRC connection request signal to the satellite based on the RRC connection setup message not being received during the specified second reference time.

10. The electronic device of claim 1, wherein at least one processor, individually and/or collectively, is configured to switch at least one of the functions related to satellite communication or communication circuits to an inactive state based on the transmission of signals related to the RACH.

11. A method of operating an electronic device, the method comprising:
identifying a transmission delay time of a satellite based on the satellite being detected;
transmitting a signal related to a random access channel (RACH) to the satellite;
switching the electronic device to an inactive state, based on transmission of the signal related to the RACH; and
switching the electronic device to an active state to identify a response signal related to the RACH based on the inactive time configured based on the transmission delay time of the satellite elapsing.

12. The method of claim 11, wherein the identifying the transmission delay time of the satellite comprises identifying the transmission delay time of the satellite, based on at least one of reference delay information defined in a standard related to a satellite, timing information received from the satellite, or a transmission delay time based on the orbit of the satellite.

13. The method of claim 11, wherein the inactive time is configured based on the operation mode of the satellite and the transmission delay time of the satellite.

14. The method of claim 13, wherein the operation mode of the satellite includes at least one of bent-pipe method or regenerative method.

15. The method of claim 11, wherein the switching to an inactive state comprises:
switching the electronic device to an inactive state, based on transmission of a RACH preamble to the satellite; and
driving a timer that runs for the inactive time configured based on the transmission delay time of the satellite.

16. The method of claim 15, wherein the identifying the response signal related to the RACH comprises:
switching the electronic device to an active state based on driving the timer expiring; and
identifying whether the RACH response message is received during a first reference time specified based on the switching time point to the active state.

17. The method of claim 16, further comprising:
retransmitting the RACH preamble to the satellite based on the RACH response message not being received during the specified first reference time.

18. The method of claim 16, further comprising:
transmitting a radio resource control (RRC) connection request message to the satellite based on the RACH response message being received within the specified first reference time;
switching the electronic device to an inactive state, based on transmission of the RRC connection request signal; and
switching the electronic device to an active state to identify an RRC connection setup message based on the inactive time elapsing.

19. The method of claim 18, wherein the identifying the RRC connection setup message comprises:
identifying whether the RRC connection setup message is received during a second reference time specified based on the switching time point to the active state; and
determining that the RRC connection with the satellite is established based on the RRC connection setup message being received within the specified second reference time.

20. The method of claim 16, further comprising:
retransmitting the RRC connection request signal to the satellite based on the RRC connection setup message not being received during a specified second reference time
